(19) United States
(12) Patent Application Publication
(10) Pub. No.: US 2025/0347901 A1
(43) Pub. Date: Nov. 13, 2025

(54) MIRRORS, METHODS OF FABRICATING MIRRORS, AND FABRY-PÉROT RESONATOR

(71) Applicants: Yale University, New Haven, CT (US); GOVERNMENT OF THE UNITED STATES OF AMERICA, AS REPRESENTED BY THE SECRETARY OF COMMERCE, Gaithersburg, MD (US)

(72) Inventors: Scott Diddams, New Haven, CT (US); Franklyn Quinlan, New Haven, CT (US); Peter Rakich, New Haven, CT (US); Prashanta Kharel, New Haven, CT (US)

(21) Appl. No.: 18/860,961

(22) PCT Filed: Apr. 27, 2023
(86) PCT No.: PCT/US2023/020253

§ 371 Date: Oct. 28, 2024

Related U.S. Application Data
(60) Provisional application No. 63/335,938, filed on Apr. 28, 2022.

(51) Int. Cl. G02B 17/00; G02B 5/10

(52) U.S. Cl. CPC G02B 17/004; G02B 5/10

(57) ABSTRACT

Provided herein are mirrors, methods of fabricating the mirrors, and Fabry-Pérot resonators including the mirrors. The mirrors include a radius of curvature between about 10⁻⁴ m and about 10⁻² m and a finesse of greater than about 10⁶ and/or a sub-Angstrom surface roughness. The method includes flowing photoresist onto a substrate, removing a portion of the photoresist, subjecting a remaining portion of the photoresist to reflow under exposure to a solvent vapor, etching the substate and the remaining portion of the photoresist to produce an etched substrate, and applying a mirror coating the etched substrate. The Fabry-Pérot resonator includes a first mirror, and a second mirror parallel to the first mirror such that light is reflected between the first mirror and the second mirror, wherein at least one of the first mirror or the second mirror includes the mirror disclosed herein.

### CROSS-REFERENCE TO RELATED APPLICATIONS

The present application claims priority under 35 U.S.C. § 119 (e) to U.S. Provisional Patent Application No. 63/335,938, filed Apr. 28, 2022, which application is incorporated herein by reference in its entirety.

### STATEMENT REGARDING FEDERALLY SPONSORED RESEARCH OR DEVELOPMENT

This invention was made with government support under FA9453-19-C-0029 and HR0011-22-2-0009 awarded by DARPA. The government has certain rights in the invention.

### BACKGROUND OF THE INVENTION

Fabry-Pérot (FP) optical cavities consisting of high-reflectivity mirrors are widely used across fundamental and applied physics. Examples include sensitive spectroscopy, optical clocks, atom trapping, and cavity quantum electrodynamics. Beyond technical noise, fundamental instabilities due to thermorefractive, thermoelastic, and Brownian motion noise degrade the frequency stability of all FP optical cavities. As the size shrinks these factors have greater impact, which is a particularly significant problem for cavities in which the light resonates in the dielectric medium, such as whispering gallery mode (WGM) and waveguide resonators. Beyond stochastic noise, typical material CTE of 10⁻⁵ demands un-realistic temperature control at the nK level to reach a 10⁻¹⁴ stability range.

All such optical cavities require a means to trap a light beam in a closed path (called a mode), such that the mode has very low loss. Traditional FP cavities use small batch mirror processing, hand assembly of each individual cavity, and light coupling with bulk optics. Typically, these techniques have employed the low loss mirrors comprised of mechanically polished substrates that are coated with ion-beam-sputtered dielectric coatings. Therefore, while compact cavities are limited by thermal noise, larger FP cavities with comparatively improved frequency stability are not appropriate for use outside the lab and are not amendable to scaled production.

Accordingly, there is a need in the art for articles and methods that improve on existing articles and methods by providing FP cavities with improved frequency stability that can be produced at scale. The present invention addresses this need.

### SUMMARY OF THE INVENTION

In one aspect, the invention provides mirror including a radius of curvature between about 10⁻⁴ m and about 10⁻² m, and a finesse greater than about 10⁶ with a center wavelength between about 200 nm and about 5 microns. In some embodiments, the finesse of the mirror is greater than about 10⁶ over wavelengths selected from the group consisting of: ultraviolet (UV), visible light, and infra-red.

In another aspect, the invention provides a mirror including a radius of curvature between about 10⁻⁴ m and about 10⁻² m, and sub-Angstrom surface roughness. In some embodiments, the mirror is reflective of one or more wavelengths selected from the group consisting of: ultraviolet (UV), visible light, and infra-red.

In some embodiments, the mirror includes a substrate, wherein the substrate comprises one or more patterns erected on a surface thereof, and wherein the one or more patterns have a smooth and curved side and a concave center.

In another aspect, the invention provides a method of fabricating a mirror, the method including flowing photoresist onto a substrate, removing a portion of the photoresist, subjecting a remaining portion of the photoresist to reflow under exposure to a solvent vapor, etching the substate and the remaining portion of the photoresist to produce an etched substrate, and applying a mirror coating the etched substrate. In some embodiments, the removing step further includes exposure to pattern of light, exposure to an electron beam, and/or machining. In some embodiments, the photoresist is selected from the group consisting of: positive photoresist and negative photoresist. Also provided herein is a mirror fabricated according to the method.

In another aspect, the invention provides a Fabry-Pérot resonator including a first mirror, and a second mirror parallel to the first mirror such that light is reflected between the first mirror and the second mirror, wherein at least one of the first mirror or the second mirror is a mirror according to the embodiments disclosed herein. In some embodiments, the Fabry-Pérot resonator acts as a stable Gaussian beam resonator. In some embodiments, the Fabry-Pérot resonator further includes a spacer between the first mirror and the second mirror. In some embodiments, each of the first mirror, the second mirror, and the spacer consist of ultra-low-expansion (ULE) glass.

In another aspect, the invention provides a Fabry-Pérot resonator including a first mirror, and a second mirror parallel to the first mirror such that light is reflected between the first mirror and the second mirror, wherein at least one of the first mirror or the second mirror has a diameter less than or equal to five times a waist width of a Gaussian beam confined by the first mirror and the second mirror. In some embodiments, the Fabry-Pérot resonator further includes a spacer between the first mirror and the second mirror. In some embodiments, each of the first mirror, the second mirror, and the spacer consist of ultra-low-expansion (ULE) glass.

In another aspect, the invention provides a Fabry-Pérot resonator according to the embodiments disclosed herein integrated with a photonic integrated circuit.

### BRIEF DESCRIPTION OF THE DRAWINGS

The following detailed description of preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements and instrumentalities of the embodiments shown in the drawings.

FIGS. 1A-1D show graphs and images illustrating fabrication and performance of miniature Fabry-Pérot reference cavities. (A) Calculations of thermal noise-limited frequency stability for miniature Fabry-Pérot cavities consisting of mirrors with large radius of curvature (ROC). (B) Demonstrated performance of state-of-the-art compact cavities and predicted performance of our invention labeled “proposed system”. (C) Lithographically produced mirrors with user-designed ROC. (D) The envisioned planar design of our waveguide-coupled miniature Fabry-Pérot reference cavity. Total volume is envisioned to be less than 1cc.

FIGS. 2A-2D show graphs and images illustrating micromirror fabrication techniques. (A) The shaded regions and points illustrate the achievable geometry (radius of curvature) and finesse of different techniques. Grey corresponds to prior work including laser ablation (circles), isotropic chemical etching (triangles) and traditional polishing. Blue corresponds to this work. Filled points indicate measured finesses, while unfilled points indicate fabricated mirror templates with predicted finesses. Note that these reference finesse values were measured at different optical wavelengths, which will modify the impact of surface scattering. (B) Illustration of the cavities built in this work. (C) Image of an array of 58 reflowed photoresist disks on a two-inch wafer that can be etched to make mirror templates. Non-circular devices on the outer ring are intended for alignment purposes. (D) Profile of a fabricated mirror template with R˜1 m.

FIGS. 3A-3C show images and graphs illustrating micromirror fabrication process flow. (A) Single layer photoresist process flow-beginning with a single layer photoresist pattern (panel a), a timed solvent vapor reflow is applied to form a large concave photoresist pattern (panel b), which is transferred into the substrate through a reactive ion etch (panels c and d) before final application of mirror coating (panel e). (B) Multilayer photoresist process flow-beginning with a multilayer photoresist pattern (pattern f), a timed solvent vapor reflow is applied to form a small concave photoresist pattern (panel g), which is transferred into the substrate through a reactive ion etch (panels h and i) before final application of mirror coating (panel j). (C) Exemplary measured profiles (black) of reflowed structures with R from 1 m to 100 μm. Illustrations of the approximate photoresist shape before reflow are shown in blue.

FIGS. 4A-4G show images and graphs illustrating mirror characterization and cavity performance evaluation. (A) Dark-field image taken in the center of a large-R (˜1 m) microfabricated mirror, revealing an RMS surface roughness of 0.59 Å. (B) Histogram of cavity finesse measurements for different R micromirrors. (C) Summary of cavity finesse measurements for different R micromirrors. In B and C, 43 cavities, formed on 5 substrates (both Fused Silica and ULE) were measured. Exemplary small- and large-R cavities are highlighted in blue and red respectively, with underlying ringdown data shown in F and G. (D) Image of small-R mirror array, corresponding to the dashed box in C. (E) Image of large-R mirror array on ULE substrate (triangles in c) with the mirrors highlighted in false color. (F-G) Averaged transmission ringdown of (F) a small-R (R=4 mm, L=320 μm) and (G) a large-R (R=1.2 m, L=5.5 mm) cavity, where the light is cut off at t=0. Black line is exponential fit yielding 410 ns and 6.1 μs decay time, corresponding to a finesse of 1.20 million and 1.04 million, respectively.

FIGS. 5A-5C show images illustrating integrated microcavity outlook. (A) Illustration of large-scale micro-Fabry-Pérot assembly and integration, in which a planar mirror wafer is bonded to a micromachined spacer layer and a micromirror array wafer. (b-d) Illustration of possible applications: (B) Integration of micro-Fabry-Pérot with photonic integrated circuit (PIC). (C) Bonding of recessed mirrors to form low-volume resonators for cavity QED.

FIG. 6 shows an image illustrating a reflow apparatus.

FIGS. 7A-7D show images and graphs illustrating reflow of single-level photoresist patterns. (A) Fabrication sequence for single-level photoresist disks. (B) Shape evolution of single-level photoresist disks under reflow. Two disks with different diameters were reflowed under the same conditions and their shapes were checked at the at 30 minute intervals. At each point, the reflow was paused and excess solvent was baked out. The left panel shows a 1.9 mm diameter disk which reflows into the desired concave shape with a large aperture at 60 min. The right panel shows a 1.2 mm diameter disk which reflows completely into a convex shape after 90 minutes. (C) An empirical relation between the mirror radius of curvature R and the diameter of resist disks D. (D) Linecuts of mirror profiles produced by reflowed single-level photoresist.

FIGS. 8A-8C show images and graphs illustrating reflow of two-level photoresist patterns. (A) Fabrication sequence for two-level photoresist disks. (B) Linecuts of mirror profiles produced by a single-level pattern (on the left) and a two-level pattern (on the right) with the same disk diameter. (C) 3D profile and cross-section of a mirror template with the smallest R fabricated in this work.

FIGS. 9A-9C show images illustrating control of mirror shapes. (A) Schematic of a plano-concave Fabry-Pérot cavity built with our fabricated mirror. The cavity has a length of L, and a curved mirror with radius of curvature R, effective mirror aperture diameter d_{eff} and mirror depth h_{eff}. The Gaussian beam radius at the curved mirror is denoted as w. (B) Several resist pattern strategies for better shape control and the anticipated resist shapes after reflow: (i) Two-level pattern, (ii) hole pattern, (iii) array of holes and (iv) grey-scale pattern. (C) 3D profile and linecut of a reflowed hole array following (biii).

FIGS. 10A-10C show an image and graphs illustrating ringdown measurements. (A) Optical setup. (B) Demonstration of system response time, using a faster calibration cavity. The ringdown of this faster cavity is seen in orange, demonstrating that the system (modulator, detector, amplifiers, triggers, etc) has sufficienty fast response time to measure our fastest ringdowns (e.g. the blue data, corresponding to one of the shortest measured cavities). (C) Example of ringdown trace averaging.

### DETAILED DESCRIPTION

### Definitions

Unless defined otherwise, all technical and scientific terms used herein have the same meaning as commonly understood by one of ordinary skill in the art to which the invention pertains. Although any methods and materials similar or equivalent to those described herein can be used in the practice for testing of the present invention, the preferred materials and methods are described herein. In describing and claiming the present invention, the following terminology will be used.

It is also to be understood that the terminology used herein is for the purpose of describing particular embodiments only, and is not intended to be limiting.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform the disclosed methods.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

### DESCRIPTION

Provided herein, in some embodiments, are ultra-low roughness mirrors including a sub-Angstrom roughness. Additionally or alternatively, in some embodiments, the mirrors include an ultra-high finesse. The ultra-high finesse includes a finesse of at least 700,000, at least 10⁶, greater than 10⁶, or any suitable combination, sub-combination, range, or sub-range thereof. The mirrors may be formed from any suitable material, such as, but not limited to, fused silica, ultra-low-expansion (ULE) glass, silicon, GaAs, sapphire, other low thermal expansion materials, and/or any other suitable material that can be polished to an ultra-low roughness level and etched while preserving surface quality.

In some embodiments, the ultra-low roughness and/or ultra-high finesse mirrors are reflective over various wavelengths, such as, but not limited to, ultraviolet (UV), visible light, and infra-red. For example, in some embodiments, the mirrors provide an ultra-high finesse of at least about 700,000 with a center wavelength of between about 200 nm and about 5 microns. In another example, the mirrors provide an ultra-high finesse of at least about 10⁶ with a center wavelength of between about 200 nm and about 5 microns.

The ultra-low roughness and/or ultra-high finesse mirrors disclosed herein include any suitable radius of curvature. Suitable radii of curvature include, but are not limited to, between about 10⁻⁴ m (100 μm) and about 10⁰ m (1 m), between about 10⁻⁴ m and about 10⁻² m, between about 10⁻⁴ m and greater than about 10⁰ m, greater than about 10⁰ m, or any suitable combination, sub combination, range, or sub-range thereof. For example, in some embodiments, the ultra-low roughness and/or ultra-high finesse mirrors include a radius of curvature of between about 10⁻⁴ m and about 10⁻² m.

In some embodiments, the mirrors include a substrate with one or more patterns erected on a surface thereof. The pattern(s) include any suitable shape for providing a desired radius of curvature. For example, in some embodiments, the one or more patterns have a smooth and curved side and a concave center. In such embodiments, the smooth and curved side together with the concave center provide the radius of curvature. As will be appreciated by those skilled in the art, the shape of the one or more patterns may be varied while still providing a desired radius of curvature, and any such variation is expressly contemplated herein.

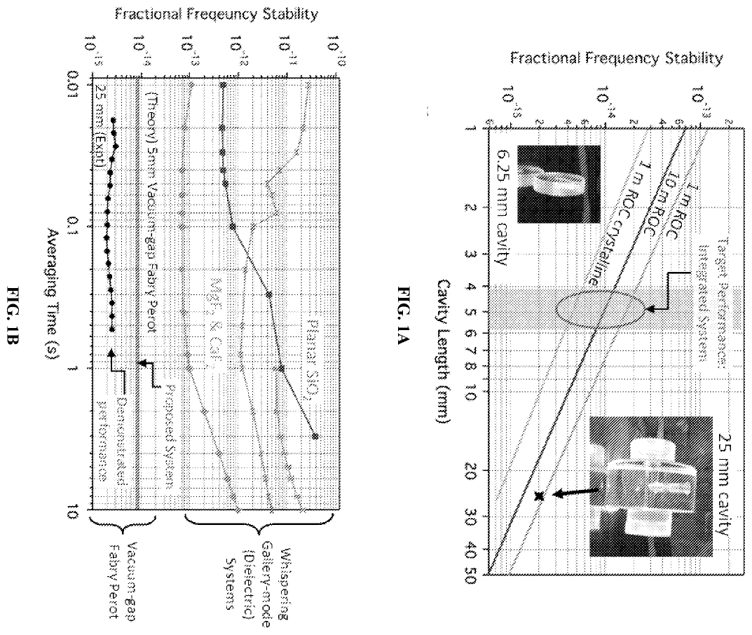

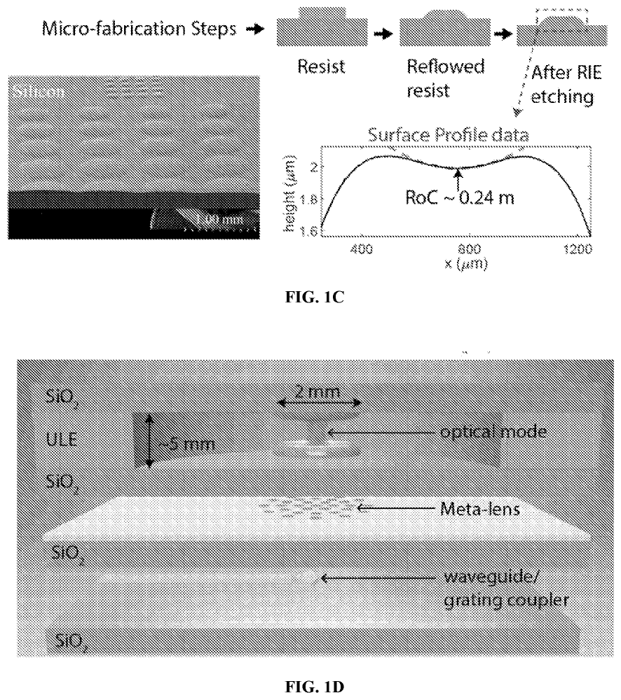

Also provided herein are methods of fabricating the mirrors disclosed herein. In some embodiments, as illustrated in FIG. 1C, the method includes creating the ultra-low roughness and/or ultra-high finesse through reflow and reactive ion etch. For example, in some embodiments, the method includes flowing photoresist onto a substrate, removing a portion of the photoresist, subjecting a remaining portion of the photoresist to reflow under exposure to a solvent vapor, etching the substate and the remaining portion of the photoresist to produce an etched substrate, and applying a mirror coating the etched substrate. In some embodiments, the removing step includes exposing to pattern of light, exposing to an electron beam, and/or machining. Suitable photoresist includes, but is not limited to, positive photoresist and negative photoresist.

Using the methods disclosed herein, the mirrors may be formed with any suitable user-defined radii of curvature. Suitable user-defined radii of curvature include any of the radii of curvature disclosed herein, such as, but not limited to, between about 10⁻⁴ m and greater than about 10⁰ m. In some embodiments, the user-defined radii of curvature is formed on a mirror template with millimeter cross-section. In some embodiments, the method includes producing the mirrors at wafer-scale.

Further provided herein is a Fabry-Pérot (FP) resonator. In some embodiments, the FP resonator includes a first mirror and a second mirror. The second mirror is parallel or substantially parallel to the first mirror, such that light is reflected between the first mirror and the second mirror. At least one of the first mirror or the second mirror includes an ultra-low roughness and/or ultra-high finesse mirror according to one or more of the embodiments disclosed herein. In some embodiments, the FP resonator also includes a spacer between the first mirror and the second mirror. Additionally or alternatively, in some embodiments, the FP resonator is air- or vacuum-spaced.

In some embodiments, the first mirror and the second mirror include micro-fabricated mirrors. In such embodiments, the FP resonator may include a miniature FP cavity. For example, in some embodiments, the FP resonator includes an FP cavity with a volume of less than 1 cc.

The first mirror, the second mirror, and/or the spacer may be formed from any suitable material, such as, but not limited to, fused silica, ultra-low-expansion (ULE) glass, silicon, GaAs, sapphire, low-thermal expansion materials, and/or any other suitable material that can be polished to an ultra-low roughness level and etched while preserving surface quality. For example, in some embodiments, the first mirror, the second mirror, and the spacer are formed from ULE. In another example, the first mirror, the second mirror, and the spacer are formed from fused silica.

In some embodiments, the FP resonator acts as a stable Gaussian beam resonator. In some embodiments, at least one of the first mirror or the second mirror has a diameter less than or equal to five times a waist width of a Gaussian beam confined by the first mirror and the second mirror. Additionally or alternatively, in some embodiments, the FP resonator provides scattering losses at the ˜1 ppm level while supporting the ultra-high finesse levels disclosed herein.

As illustrated in FIGS. 1A and 1B, the FP cavity according to the embodiments disclosed herein provides low phase noise and supports frequency stability at the 10⁻¹⁴ level. Without wishing to be bound by theory, it is believed that this level is at least a factor of 10 below that exhibited by existing quartz crystal oscillators. Accordingly, in some embodiments, the FP resonators disclosed herein enable frequency stabilization of lasers for a wide range of experiments in precision optical frequency metrology, timekeeping and quantum metrology. Through the ability to scale production of the mirrors disclosed herein, such as through wafer-scale production, the FP resonators including such mirrors may be mass-fabricated. In some embodiments, mass-fabricating the FP resonators includes mass-fabricating a two-dimensional array of Fabry-Pérot cavities in parallel. For example, the components of the FP resonators can be fabricated on planar substrates, then stacked, bonded, and diced into individual cavities.

In some embodiments, the mass-fabricated FP cavities are then directly interfaced and/or integrated with one or more other components, such as, but not limited to, fiber or waveguide integrated optics, waveguide grating couplers, and/or metalenses for coupling light into and extracting light from the Fabry-Pérot cavity. For example, in some embodiments, as illustrating in FIG. 1D, the FP resonator includes a stacked and bonded structure where light is coupled to the vacuum-gap FP cavity via an integrated grating coupler and meta-lens. In another example, the FP resonator is directly interfaced with an optical fiber. In another example, the FP resonator is integrated with a photonic integrated circuit (PIC).

The following examples further illustrate aspects of the present invention. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

### EXAMPLES

### Example 1

Due to their unrivaled performance and versatility, ultra-high-finesse Fabry-Pérot resonators have enabled scientific and technological breakthroughs in fields ranging from cavity QED to optical clocks and precision metrology. To obtain these performance advantages within compact and scalable new technologies (chip-scale optical clocks, quantum processors), integrated Fabry-Pérot resonator solutions will be required. However, it has proven difficult to identify a scalable microfabrication approach that can yield world-class resonator performance and produce the range of resonator geometries needed to meet the varied demands of emerging technologies. In this paper, we demonstrate a wafer-scale fabrication technique that produces arrays of ultra-high-finesse (≥10⁶) mirrors with a user-defined radius of curvature spanning four orders of magnitude (10⁻⁴-10⁰ m). We employ photoresist reflow and reactive ion etching to shape and transfer mirror templates into a substrate while maintaining sub-Angstrom roughness. This substrate is coated and used to create arrays of compact Fabry-Pérot resonators with finesse values as high as 1.3 million and measured excess loss <1 ppm. Optical ringdown measurements of 43 devices across 5 substrates reveal that the fabricated cavity mirrors—with both small and large radii of curvature—produce an average coating-limited finesse of 1.05 million. This versatile new approach opens the door to scalable fabrication of high-finesse miniaturized Fabry-Pérot cavities needed for next-generation quantum optics and frequency metrology technologies.

### INTRODUCTION

Among optical resonators, ultrahigh-finesse Fabry-Pérot cavities produce unrivaled frequency stability, quality factors, and power handling, enabling scientific and technological breakthroughs in a broad range of applications. For the next generation in quantum communications, computation, and time-keeping systems, it will be necessary to bring these performance advantages to compact, integrated platforms. This will require a scalable fabrication technique that is flexible enough to meet the varied demands of disparate applications. Many applications benefit from increased finesse, which translates to larger intracavity fields, increased storage times, and narrower linewidths. But geometry can be equally important, as the optimal mode volumes and spot size can vary dramatically for different applications, placing different requirements on the mirror radius of curvature (R). In quantum optics, where the cooperativity between single atoms and optical resonators scales inversely with mode area, microcavity geometries with small radius of curvature (R˜10⁻⁴-10⁻² m) are desirable. Conversely, for ultra-stable reference cavities in timekeeping applications, frequency noise can be minimized by averaging over thermal fluctuations with large mode areas, requiring large a radius of curvature (R˜1 m).

Increasing finesse ( [symbol] ) includes decreasing all sources of optical loss within the cavity. This is seen from the definition, [symbol] =π/(T+A+S), where T, A, and S represent the fractional energy loss (per mirror) resulting from transmission, absorption, and scattering. Thus, an ultra-high finesse resonator ( [symbol] >10⁶) that balances transmission with excess losses requires mirror with S+A at the 1 ppm level. Using ion-beam sputtering deposition techniques, highly uniform dielectric coatings with absorptive losses (A) of ˜1 ppm are available (G. Rempe, R. J. Thompson, H. J. Kimble, and R. Lalezari, “Measurement of ultralow losses in an optical interferometer,” Optics Letters 17, 363-365 (1992)). However, roughness on the mirror surface and subtle imperfections in the mirror shape can both contribute to unwanted scattering losses, resulting in stringent requirements on the surface quality of the mirror template. For example, at telecom wavelengths, a mirror template with an ideal surface profile (i.e., without any low spatial frequency shape imperfections) must have sub-Angstrom RMS surface roughness to achieve scattering losses(S) below 1 ppm levels.

Specialized chemical-mechanical polishing techniques, sometimes referred to as super-polishing (J. Nelson and S. Iles, “Creating sub angstrom surfaces on planar and spherical substrates,” in Optifab 2019, Vol. 11175 (SPIE, 2019) pp. 6-16), are traditionally used to meet these stringent requirement on individually polished discrete mirror components. This polishing technique can achieve the necessary sub-Angstrom roughness, but only for large radius of curvature mirrors (R˜10 mm-1000 mm). Motivated by quantum optics, new fabrication techniques utilizing laser ablation of glass, and chemical etching of silicon have been developed in recent years, finding applications in a wide range of experiments (Benjamin Merkel, Alexander Ulanowski, and Andreas Reiserer, “Coherent and Purcell-Enhanced Emission from Erbium Dopants in a Cryogenic High-Q Resonator,” Physical Review X 10, 041025 (2020); Hiroki Takahashi, Ezra Kassa, Costas Christoforou, and Matthias Keller, “Strong Coupling of a Single Ion to an Optical Cavity,” Physical Review Letters 124, 013602 (2020); Matthias Steiner, Hendrik M. Meyer, Christian Deutsch, Jakob Reichel, and Michael Kohl, “Single Ion Coupled to an Optical Fiber Cavity,” Physical Review Letters 110, 043003 (2013); A. D. Kashkanova, A. B. Shkarin, C. D. Brown, N. E. Flowers-Jacobs, L. Childress, S. W. Hoch, L. Hohmann, K. Ott, J. Reichel, and J. G. E. Harris, “Superfluid Brillouin optomechanics,” Nature Physics 13, 74-79 (2017); N. E. Flowers-Jacobs, S. W. Hoch, J. C. Sankey, A. Kashkanova, A. M. Jayich, C. Deutsch, J. Reichel, and J. G. E. Harris, “Fiber-cavity-based optomechanical device,” Applied Physics Letters 101, 221109 (2012); Erika Janitz, Maximilian Ruf, Mark Dimock, Alexandre Bourassa, Jack Sankey, and Lilian Childress, “Fabry-Pérot microcavity for diamond-based photonics,” Physical Review A 92, 043844 (2015); Roland Albrecht, Alexander Bommer, Christian Deutsch, Jakob Reichel, and Christoph Becher, “Coupling of a Single Nitrogen-Vacancy Center in Diamond to a Fiber-Based Microcavity,” Physical Review Letters 110, 243602 (2013)).

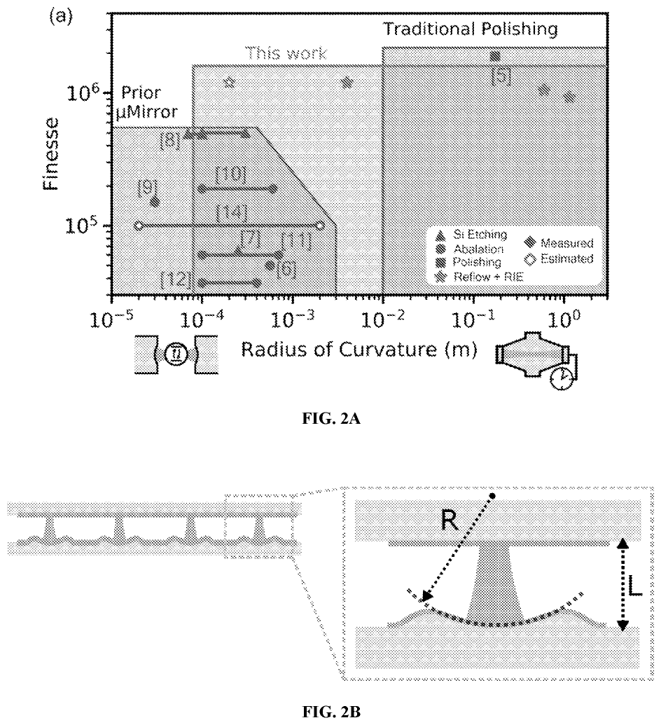

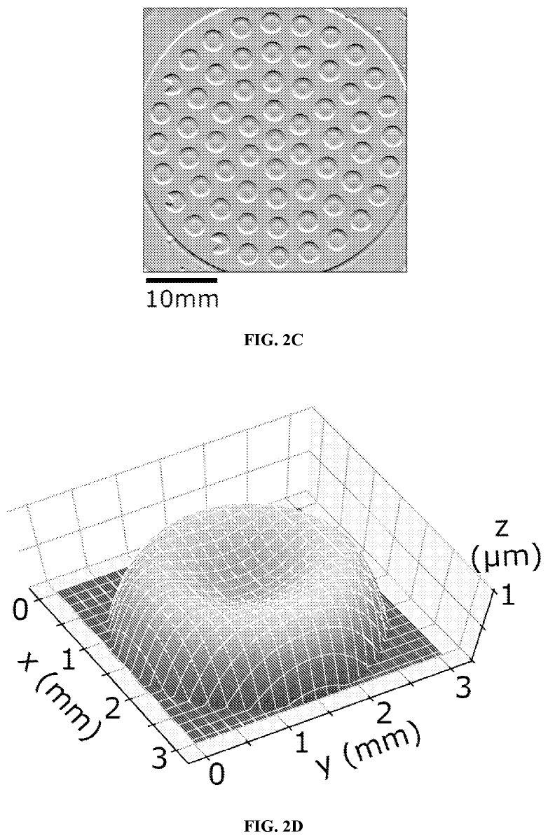

While these new techniques have the potential for scalable fabrication, they are limited to the production of small R(<1 mm) mirrors, with finesse values that fall short of traditional polishing techniques (see comparison in FIG. 2A). Thus, it remains an outstanding goal to identify a scalable fabrication technique that yields ultrahigh finesse mirrors, with access to both small and large mode volumes.

### DISCUSSION

In this Example, we demonstrate a wafer-scale fabrication technique that produces ultra-high-finesse (≥10⁶) mirrors with a user-defined R spanning from 100 microns to 1 meter (FIG. 2B), necessary to satisfy the demanding needs of applications ranging from quantum optics to low-noise laser oscillators. Arrays of microfabricated mirrors are formed on a single substrate using a solvent-vapor based resist reflow process. Through this process, photoresist defines mirror shapes that are transferred into a substrate using an optimized dry etch, maintaining sub-Angstrom surface roughness. Multilayer mirror coatings are then deposited, creating arrays of compact Fabry-Pérot resonators whose performance is evaluated using optical ring-down measurements. Measurements of 43 devices across 5 substrates reveal that the fabricated cavity mirrors—with both small and large radii of curvature—produce a mean (maximum) coating-limited finesse of 1.05 million (1.3 million), which, to the best of our knowledge, sets a record among micro-fabricated mirrors (and R<10 mm mirrors in general). This versatile new approach opens the door to scalable fabrication of high-finesse miniaturized Fabry-Pérot cavities needed for a wide range of next-generation quantum optics and frequency metrology technologies.

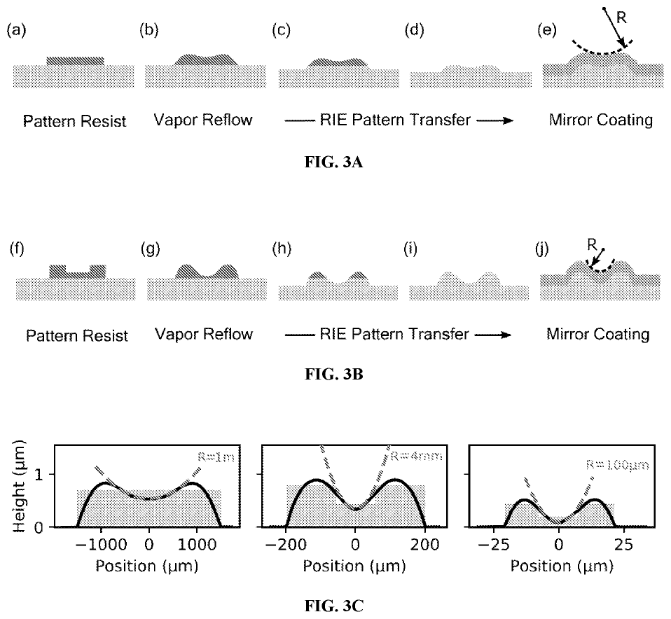

Through this fabrication approach, we use reflow techniques to create a resist profile that defines the shape of our mirror. Photoresist patterns are first created on a super-polished substrate (e.g. fused silica) using UV lithography. The single- and multi-level photoresist patterns, seen in FIGS. 3A (panel a) and 3B (panel f), are used to form large- and small-R devices, respectively. These resist patterns undergo reflow in a purpose-built solvent-vapor chamber; as the photoresist absorbs the solvent vapor, surface tension rounds any sharp corners as it seeks to minimize the surface area of the resist pattern. In the limit of complete reflow, this disk is transformed into a dome; however, for intermediate reflow times, a smooth parabolic surface is formed in the center of the resist pattern, as illustrated in FIGS. 3A (panel b) and 3B (panel g). An array of 58 such reflowed surfaces formed on a two-inch wafer is shown in FIG. 2C. When the photoresist pattern reaches the desired shape, the reflow process is halted, and the resist pattern is transferred into the substrate using an optimized reactive ion etch (Li Li, Takashi Abe, and Masayoshi Esashi, “Smooth surface glass etching by deep reactive ion etching with SF6 and Xe gases,” Journal of Vacuum Science & Technology B: Microelectronics and Nanometer Structures Processing, Measurement, and Phenomena 21, 2545-2549 (2003); M. D. Minnick, G. A. Devenyi, and R. N. Kleiman, “Optimum reactive ion etching of x-cut quartz using SF6 and Ar,” Journal of Micromechanics and Microengineering 23, 117002 (2013)), as illustrated in FIGS. 3A (panels c-d) and 3B (panels h-i). At this point, a multilayer dielectric coating is deposited onto these mirror templates (FIGS. 3A (panel e) and 3B (panel j)), producing an array of concave mirrors. Further details of the fabrication process can be found in Example 2.

Using this process, one can readily vary the mirror radius of curvature by 4 orders of magnitude through control of the initial photoresist geometry and reflow time. The profile of a fabricated mirror template with R˜1 m is shown in FIG. 2D. FIG. 3C shows measured profiles of etched mirror templates (black) with radii of curvature ranging from R=1 m to R=100 μm; approximate resist profiles, used at the beginning of the fabrication process, are illustrated in blue.

While the measured mirror curvature permits us to leverage Gaussian beam optics as the basis for resonator design, it is important to note that these mirror shapes deviate from a paraboloid at larger radial distances, and the mirrors have a finite size. Thus, in principle, the nontrivial surface profiles produced by the reflow process could contribute to diffractive losses and clipping losses, limiting the performance of these mirrors. To investigate limitations posed by these shape-induced losses, we developed a numerical mode solver that builds on prior techniques (Dustin Kleckner, William T M Irvine, Sumant S R Oemrawsingh, and Dirk Bouwmeester, “Diffraction-limited high-finesse optical cavities,” Physical Review A 81, 043814 (2010); Julia Benedikter, Thomas Hu\ddot{ } mmer, Matthias Mader, Benedikt Schlederer, Jakob Reichel, Theodor W H\hat{ }ansch, and David Hunger, “Transverse-mode coupling and diffraction loss in tunable Fabry-Pérot microcavities,” New Journal of Physics 17, 053051 (2015)). Using a standard (e.g. Hermite-Gaussian) mode basis, this solver encodes a round-trip of optical propagation (including the exact mirror profile) into a mode scattering matrix. This scattering matrix is then used to compute the eigenmodes of the resonator, including their associated loss rates. Simulating a plano-concave resonator geometry (FIG. 2C) using the measured mirror profile as the input, we find that the shape-induced diffractive losses of optimized mirror templates (FIG. 3B) are very small (i.e., Sₛₕₐₚₑ≤0.1 ppm).

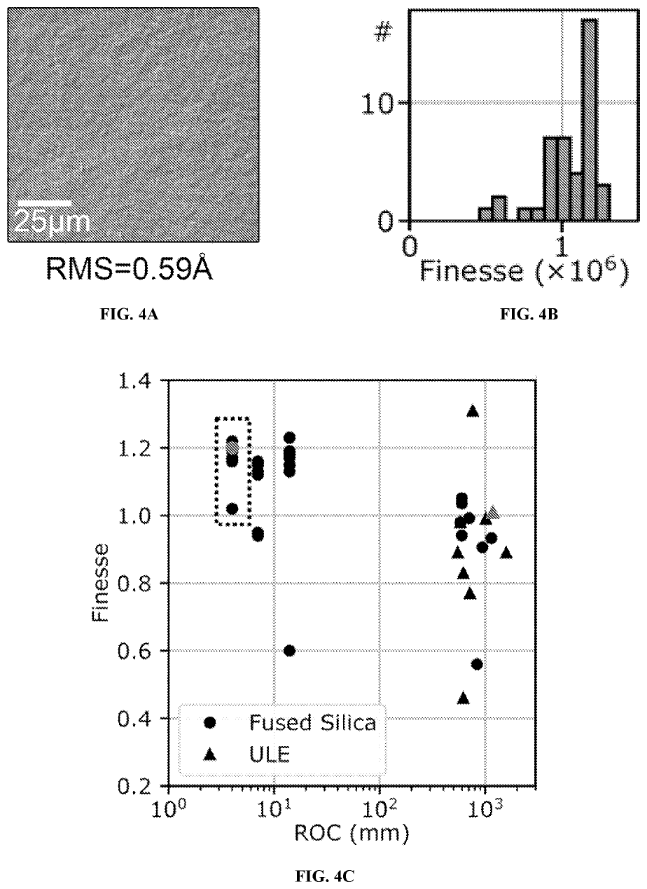

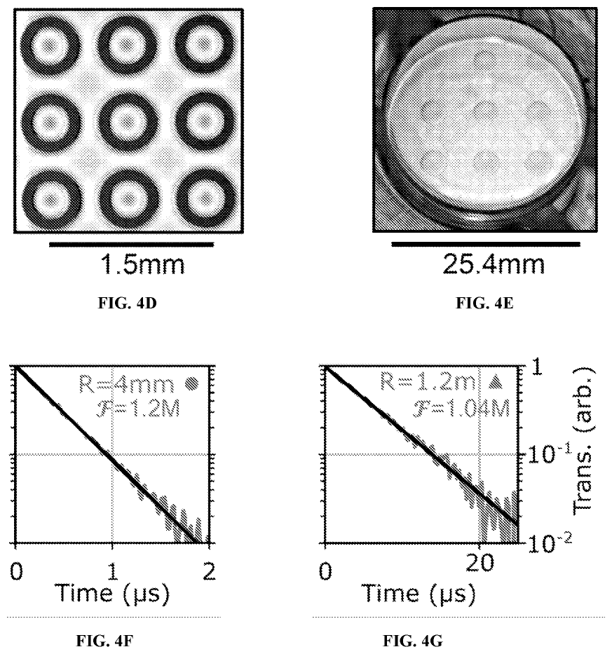

Roughness induced scattering losses is perhaps the most significant barrier to realizing a finesse of greater than 1 million. One can show that the scattering loss associated with an RMS surface roughness, σᵣₘₛ, is given by S_{rough}≅(4πσ/λ)², where i is the wavelength of light (H. E. Bennett and J. O. Porteus, “Relation between surface roughness and specular reflectance at normal incidence,” JOSA 51, 123-129 (1961)). Hence, each mirror must have sub-Angstrom surface roughness (≤1.2 Å) to meet the requirement S≤1 ppm. Therefore, the etch process that transfers the photoresist pattern must not appreciably alter the roughness of the super polished substrate. For this task, we utilize a reactive ion etch that removes material primarily through ion bombardment (i.e., a physical etch) rather than chemical processes (see Example 2, Section E for further details). FIG. 4A shows a typical surface roughness measurement taken in the center of a microfabricated mirror; this measurement reveals an RMS surface roughness of 0.59 Å, corresponding to an estimated scattering loss of S≈0.23 ppm at 1550 nm wavelengths.

The performance of these devices was evaluated by applying a state-of-the-art, ultra-low-loss dielectric mirror coating, with alternating SiO₂/Ta₂O₅ layers designed to produce reflectivity >0.99999. We then paired these substrates with flat mirrors from the same coating run, forming arrays of plano-concave Fabry-Pérot resonators. These cavities were held in kinematic mounts, or clamped/bonded to an annular spacer. Both small- and large-R mirrors were tested, spanning mode waists from 24 to 220 μm. To evaluate the finesse of each resonator, a laser was mode-matched to the fundamental cavity mode, and switched off rapidly after being brought on resonance. Sample transmission ringdowns of small- and large-R cavities are shown in FIGS. 4F and 4G. Exponential fits of these measurements reveal cavity lifetimes (T) of 410 ns and 6.1 μs for the small and large R resonator devices, corresponding to finesse values of 1.20 million and 1.04 million (using [symbol] =πτc/L, where c is the speed of light and L is the cavity length). These lifetime measurements were corroborated using microwave-calibrated frequency sweep measurements. Further measurement details are available in Example 3, Section B.

Ringdown measurements were performed on 43 cavities created using 5 different patterned micromirror substrates, with results summarized in FIGS. 4B and 4C. FIG. 4D shows an image of a small-R mirror array, corresponding to the dashed box in FIG. 4C, while FIG. 4E shows an image of a large-R mirror array on ULE substrate (with mirrors highlighted in false color), corresponding to the triangles in FIG. 4C. These measurements indicate consistent performance across the fabricated samples. The small R cavities all come from a single substrate, containing a grid of 81 micromirrors. Out of 27 mirrors tested, 24 were found to have a finesse >1 million (1.13±0.13 million). The large R cavities show slightly increased variability (0.91±0.20 million), but still reach a maximum finesse of 1.31 million. This variability is likely due to the increased tilt sensitivity of large-mode-waist cavities, which places more stringent requirements on the mirror symmetry/geometry and cavity alignment. We also note that the large R devices are fabricated on both fused silica and ultra-low-expansion (ULE) glass, confirming compatibility with these two technologically important materials.

While the finesse permits us to quantify the total mirror loss (T+S+A), it is also instructive to separate the different loss contributions. Since both mirrors of all tested microcavities were simultaneously coated, receiving an identical multilayer coating, it is reasonable to assume that the transmission coefficients (T) are identical for both mirrors. With this assumption, we can extract (S+A) from the relative transmitted and reflected powers on resonance (Christina J. Hood, H. J. Kimble, and Jun Ye, “Characterization of high-finesse mirrors: Loss, phase shifts, and mode structure in an optical cavity,” Phys. Rev. A 64, 033804 (2001)). Doing so, we estimate T=1.9 ppm for this coating, which means that, for our measured [symbol] =1.2×10⁶, we infer the excess loss to be (S+A)≈0.74 ppm. Note that since these dissipative loss channels are smaller than the external loss (T), this resonator technology offers a path to efficient light extraction at these ultrahigh finesse levels.

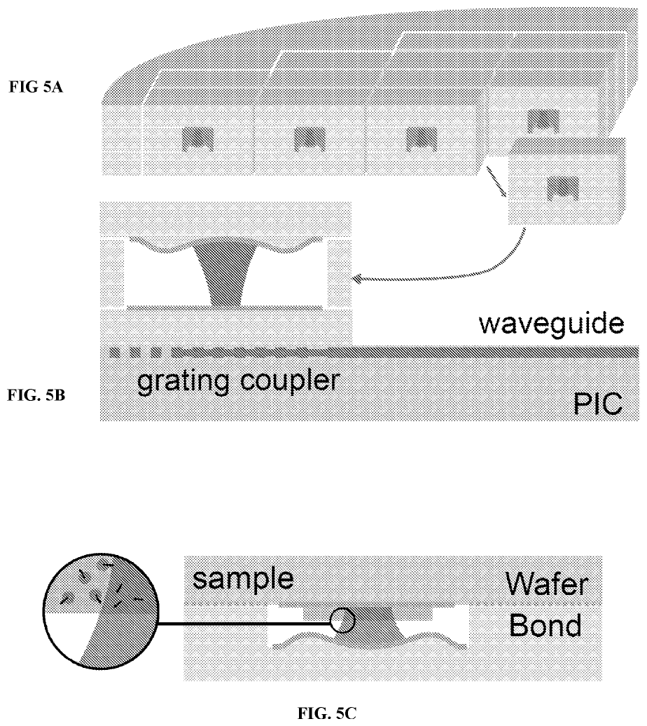

Building on these techniques, wafer-scale fabrication approaches (pictured in FIGS. 5A-5C) may be used to bring the unique advantages offered by high-finesse Fabry-Pérot resonators to integrated systems. In contrast to dielectric waveguide resonators, the mode of a Fabry-Pérot resonators can be engineered to live almost entirely in vaccum, avoiding problematic sources of thermo-refractive noise produced by dielectrics (Michael L Gorodetsky and Ivan S Grudinin, “Fundamental thermal fluctuations in microspheres,” JOSA B 21, 697-705 (2004); V B Braginsky, M L Gorodetsky, and SP Vyatchanin, “Thermo-refractive noise in gravitational wave antennae,” Physics Letters A 271, 303-307 (2000)). For this reason, ultra-high finesse cavities, of the type fabricated in this Example, could prove instrumental to satisfy the growing demand for frequency stabilized ultra-narrow linewidth lasers for atomic clocks, communications, and sensing applications. For such applications, large mode sizes (>200 μm) produced by larger radius of curvature (˜1 m) mirrors are used to suppress residual noise generated by the mirror coating. Such frequency-stabilized cavities are typically constructed from ultra-low expansion (ULE) glass to eliminate expansion-induced frequency drift. A bonded cavity assembly, using 1m-ROC micromirrors from FIG. 4C, was shown to produce a fractional frequency Allan deviation of 7×10⁻¹⁵ at 1 second, in a volume of only 8 mL This same device was also used to demonstrate self-injection lock of an integrated semiconductor laser with sub-Hz integral linewidth.

Conversely, the small-ROC mirrors can yield small mode-volumes necessary to produce enhanced coupling rates with atoms, ions, and defect centers for quantum applications (see FIG. 5C). For example, the smallest microcavities studied here (R=4 mm, L=320 μm) produce modes with a waist radius of ˜17 μm and finesse of 1.2 million, corresponding to a Purcell enhancement factor of ˜2000 (E. M. Purcell, “Spontaneous Emission Probabilities at Radio Frequencies,” in Confined Electrons and Photons: New Physics and Applications, NATO ASI Series, edited by Elias Burstein and Claude Weisbuch (Springer US, Boston, MA, 1995) pp. 839-839). Since the modes of such Gaussian beam resonators are readily mode-matched to optical fibers, they permit highly efficient collection of photons required for cavity QED and quantum networking applications.

To harness these and other performance advantages, such high finesse resonators could be integrated with planar photonic circuits using vertical-emission grating couplers (Lirong Cheng, Simei Mao, Zhi Li, Yaqi Han, and H Y Fu, “Grating couplers on silicon photonics: Design principles, emerging trends and practical issues,” Micromachines 11, 666 (2020)), as seen in FIG. 5B. In the context of integrated photonics, these high finesse resonators are also remarkable for their ability to produce very high Q-factors (Q>10 billion) within compact footprints (as small as ˜1 mm²). Hence, these resonators offer compelling performance advantages relative to state-of-the-art ring resonators (Matthew W Puckett, Kaikai Liu, Nitesh Chauhan, Qiancheng Zhao, Naijun Jin, Haotian Cheng, Jianfeng Wu, Ryan O Behunin, Peter T Rakich, Karl D Nelson, et al., “422 million intrinsic quality factor planar integrated all-waveguide resonator with sub-mhz linewidth,” Nature communications 12, 1-8 (2021)) and dielectric resonators (Anatoliy A. Savchenkov, Andrey B. Matsko, Vladimir S. Ilchenko, and Lute Maleki, EN″Optical resonators with ten million finesse,” Optics Express 15, 6768-6773 (2007), publisher: Optica Publishing Group), opening the door to scalable integrated photonic technologies.

### Methods

Mirror fabrication Shipley S18 series photoresist is patterned on a super-polished glass substrate provided by Coastline Optics. After priming the substrate with Hexamethyldisilazane (HMDS) (Li Li, Takashi Abe, and Masayoshi Esashi, “Fabrication of miniaturized bi-convex quartz crystal microbalance using reactive ion etching and melting photoresist,” Sensors and Actuators, A: Physical 114, 496-500 (2004)), we reflow the photoresist by mounting the substrate in the top of a home-made chamber filled with propylene glycol methyl ether acetate (PGMEA) vapor. The vapor is heated to ˜45° C. and the substrate is kept at an elevated temperature of ˜50° C., so that the photoresist gradually undergoes reflow without being dissolved by the vapor. When the resist disks reach the desired shape, we stop the reflow by removing the substrate from the chamber and baking out the excess solvent. This shape is then transferred into the substrate with SF₆/Ar-based reactive ion etching. High reflectivity coatings are applied by FiveNine Optics Inc. Further details are available in Examples 2 and 3.

Mirror characterization Micromirror profiles are characterized using a Zygo Nexview. These profiles are used as input for simulation tools based on numerical beam propagation and an eigenmode solver to estimate scattering loss (S in main text). In finesse measurements, cavity arrays are formed by pairing micromirrors with flat mirrors coated simultaneously. Their optical lifetimes are determined through ring-down measurements, where the decay of transmitted light is recorded after switching off a resonant excitation laser. Cavity free-spectral ranges are either measured by scanning a tunable laser or inferred from cavity length. In addition to finesse, following Christina J. Hood, H. J. Kimble, and Jun Ye, “Characterization of high-finesse mirrors: Loss, phase shifts, and mode structure in an optical cavity,” Phys. Rev. A 64, 033804 (2001), we are able to determine the excess loss (S+A) of each mirror by measuring the resonant transmission and reflection.

### Example 2—Mirror Fabrication

Leveraging hydrodynamics, we reflow lithographically-defined photoresist disks into desired mirror shapes with atomic-scale surface roughness. Using carefully engineered reactive ion etching (RIE), we transfer those shapes into substrates while maintaining its smoothness. Here, we discuss details on how we achieve mirror radii of curvature (R) spanning from 100 μm to 1 m while maintaining surface roughness at sub-Angstrom level.

### A. Reflow Apparatus

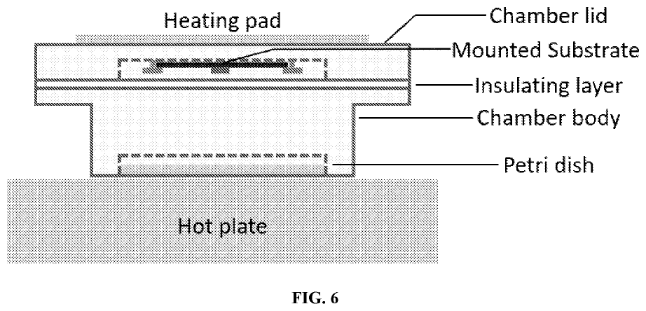

Because the desired shape of the reflowed photoresist is an intermediate state, precise control of the reflow is required to consistently obtain mirror surfaces with the desired R. To meet this requirement, we built a dedicated chamber to perform reflow under well-controlled vapor pressure and temperature. FIG. 6 shows a schematic of this apparatus. A petri dish filled with PGMEA is placed in the chamber to generate vapor, and a substrate with patterned photoresist on is mounted on the chamber lid. An insulating layer between the body and lid allows us to maintain a temperature difference between the two parts. By using a hot plate underneath the chamber and a heating pad attached to the lid, we are able to independently control the temperature of the solvent vapor (and thus its vapor pressure) and the substrate. This control ensures a gradual reflow while preventing the solvent from dissolving the photoresist. Typical temperature settings for the solvent vapor and substrate would be ˜45° C. and ˜50° C., respectively. Under this condition, a 3 mm-diameter photoresist disk will reach a concave shape in approximately one hour. As long as we maintain adequate thermalization of this apparatus, we are able to consistently reproduce the same resist shape given identical initial disk diameters and reflow times.

### B. Reflow Strategy: Large R

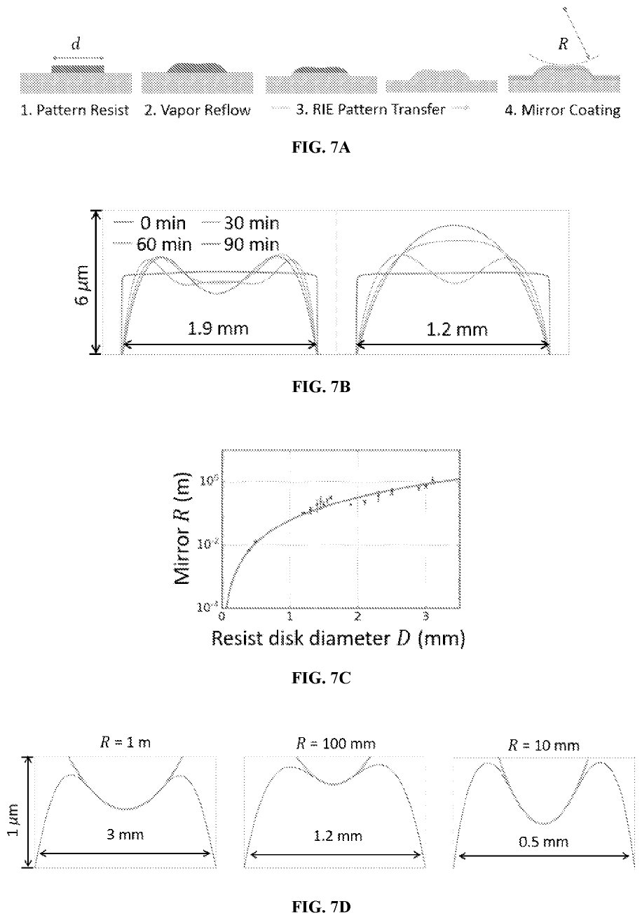

For large-R mirrors, we begin with a single-level photoresist disk (FIG. 7A). FIG. 7B shows measured resist cross sections at different intermediary times during reflow. Initially, the disk redistributes its central volume outward, rounding the disk edge and forming two humps (t=30 min in the left panel of FIG. 7B. As reflow proceeds, the humps gradually move inward, eventually merging and forming a concave surface in the middle (t=60 min in the left panel of FIG. 7B). The humps continue merging, eventually filling in the concave valley and finally reaching a convex shape (as shown in the right panel of FIG. 7B).

As shown in FIG. 7B, for a given disk diameter, the point where two humps just start to merge yields the largest aperture. This is the point at which we typically interrupt the reflow by taking the substrate out of the chamber and baking out the excess solvent. After obtaining the desired resist shape, we transfer it into the substrate by reactive ion etching (RIE). Details of our optimized RIE recipe will be presented below, but for geometric control purposes, we note that nonidentical etch rates of the substrate and photoresist will result in a vertical rescaling of the photoresist pattern. If we define the etch rate ratio of resist to substrate as s, then we find the curvature scales accordingly: Rₘᵢᵣᵣₒᵣ=sRᵣₑₛᵢₛₜ.

Under the above protocol, by sweeping the diameter of photoresist disks D from 400 μm to 3 mm, we are able to achieve R from 5 mm to 1 m. FIG. 7D shows a gallery of example mirrors with various R we have fabricated. FIG. 7C summarizes an empirical relation between the mirror R and resist diameter D (resist height 2.5 μm), where the red line is a power law fitting yielding R[m]=0.059D [mm]^{2.4}. The error in R given a particular D comes from slightly different thermal conditions and reflow timing between samples. The exact relation can in principle be calculated from hydrodynamics. We note that in principle, even small-diameter disks can reach arbitrarily large R as they transitions from concave to convex, but this is an unreliable way to reach large-R, and results in insufficient mirror apertures.

The above fabrication process, using single-level photoresist patterns, can already offer a wide range of R values and in principle reach R even smaller than 5 mm. For applications targeting ultra-small mode volumes, further shrinking the diameter of single-level resist disks may still be a viable approach to achieving small mirror R. For instance, a single-level, 60 μm-diameter resist disk can yield a mirror with R=750 μm, but the optical mode size must remain below 6 μm to achieve ultrahigh finesse at 1550 nm wavelength. Effectively, this maximum spot size w, along with R, sets an upper bound for the cavity length L. If we want to beat this limit, it is necessary to have more control over the resist shape.

### C. Reflow Strategy: Small R

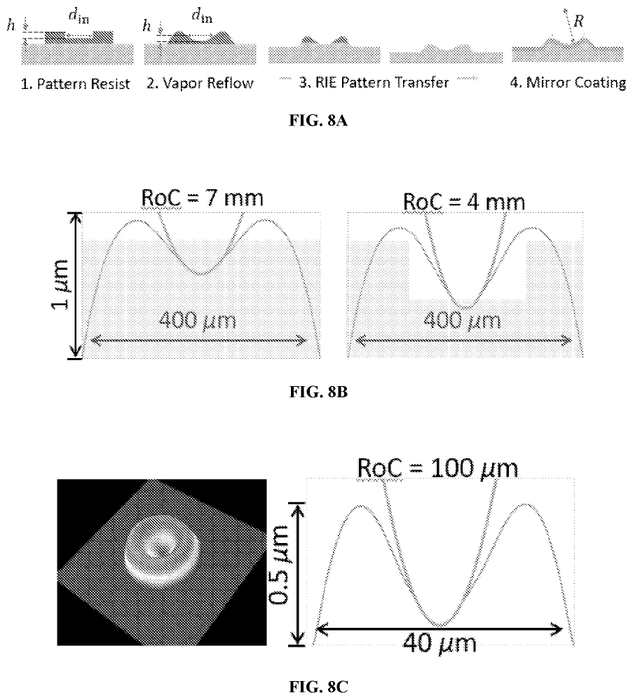

In order to extend our technique towards smaller-R mirrors, we modify the photoresist patterning described above. Knowing that the target shape of the reflowed resist has a central recess, we pattern a hole with diameter dᵢₙ and depth h in the center of the initial resist disk as a zeroth-order approximation of the final shape, as shown in FIG. 8A. For a brief reflow, we can assume that the sharp corners of the hole simply soften, maintaining the overall dimensions and forming a concave surface in the center. Hence the aperture size and recess depth of the reflowed resist will stay around dᵢₙ and h, respectively. If we further approximate the center part of the dimple as a paraboloid, we can derive its radius of curvature to be Rᵣₑₛᵢₛₜ=dᵢₙ²/8 h. Taking the etch selectivity into account, R of the etched mirror will be R=sdᵢₙ²/8 h. FIG. 8B shows cross sections of two fabricated mirrors made from single- and two-level resist patterns with the same outer diameter. The two-level pattern results in a deeper mirror recess and smaller R. FIG. 8C shows a 3D profile and a cross section of a mirror template with the smallest R we have achieved using this two-level pattern technique (R=100 μm).

### D. Reflow Strategy: Small R

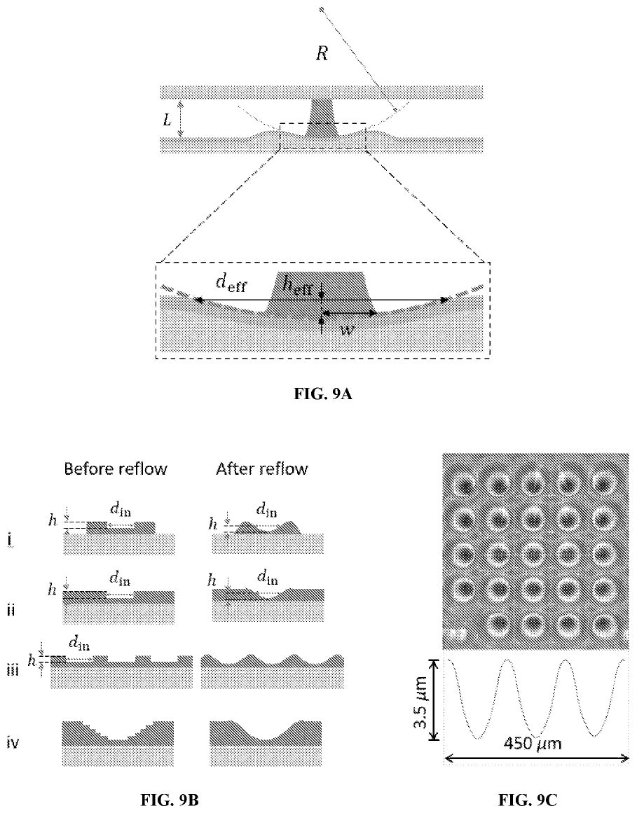

When targeting a certain R, the size of usable mirror aperture should go into design consideration to avoid clipping losses. This results in an important requirement on the mirror depth. We consider a plano-concave cavity configuration, as illustrated in FIG. 9A. For such a cavity to have stable modes, the cavity length L must be shorter than the R of the curved mirror. Under this condition, the Gaussian beam radius at the curved mirror can be expressed as

$$w = {( \frac{λ L}{π} )}^{\frac{1}{2}} {( \frac{L}{R} ( 1 - \frac{L}{R} ) )}^{- \frac{1}{4}} \qquad ( 1 )$$

where λ is the wavelength of light. We can estimate the clipping loss of a finite-sized curved mirror by assuming the energy in the Gaussian tail outside the aperture is totally lost, which yields

$${ℒ}_{clip} = exp \{ - 2 {( \frac{{d}_{eff}}{2 w} )}^{2} \} ,$$

where d_{eff} is the effective aperture diameter of the mirror, as defined in FIG. 9A. To maintain [symbol] _{clip}˜1 ppm, we require

$${d}_{eff} ≳ 5 w \qquad ( 2 )$$

For our nearly parabolic mirror profiles, this diameter can be linked to the mirror recess depth, h_{eff}, as illustrated in FIG. 9A:

$${d}_{eff} = 2 \sqrt{2 {h}_{eff} R} \qquad ( 3 )$$

Thus, we can translate our minimum aperture requirement (Eq. 2) into a condition linking the mirror depth and the achievable waist, or equivalently the maximum length for a given R by

$$\frac{L}{R} < \frac{A}{1 + A} with A = {( \frac{8 π}{25} \frac{{h}_{eff}}{λ} )}^{2} \qquad ( 4 )$$

Note in this expression, the bound is totally determined by h_{eff}/λheff/λ, where λ is the wavelength of light, and it is relaxed when h_{eff} goes up. For reference, we typically have h_{eff}=0.3 μm for reflowed single-level resist disks, which allows L/R<3.7% at 2=1550 nm. Increasing the depth to h_{eff}=1 μm enables L/R<30%.

From the above analysis, we see that in the cavity design phase, when we are given a set of cavity parameters, (e.g. L and R or target mode parameters), it is wise to first calculate h_{eff} to minimize the clipping loss. After settling the geometric parameters R and h_{eff}, or equivalently d_{eff} and h_{eff} through Eq. 3, for a certain cavity mirror, we can implement the strategy presented in Sec. C with dᵢₙ≅d_{eff} and h≅s·h_{eff} to design the initial resist shape, as illustrated in FIG. 9B (panel i). With this strategy, we note that the outer diameter of the two-level resist disk will influence the final shape of the recess. To reduce this complication, we can use another patterning strategy where we only define holes in a uniform layer of resist, as shown in FIG. 9B (panel ii). This approach also offers flexibility in making arrays of such mirrors, as illustrated in FIG. 9B (panel iii). An example of such a reflowed pattern is shown in FIG. 9C. Finally, if we want to gain further control of mirror shapes, we can move to a grey-scale patterning technique, enabled by direct laser lithography, as illustrated in FIG. 9B (panel iv).

### E. Surface Quality Control

Our micro-fabricated mirrors begin with super-polished flat substrates with sub-Angstrom surface roughness, and it is crucial that our fabrication does not significantly alter this surface figure. The reflow process inherently generates a smoothed mirror template, eliminating unwanted high-frequency surface texture. Therefore, we mainly need to ensure that the surface quality is not degraded by the reactive ion etch or by unwanted defects in the substrates and photoresist.

To achieve smooth transfer of the reflowed pattern, we develop an RIE recipe that preserves the surface quality of both the photoresist and substrates. Reactive ion etching of quartz/fused silica has been studied extensively. In particular, it has been shown that a plasma based on SF₆ with a greater concentration of heavy noble gases (Ar or Xe) under low pressure can preserve ultrasmooth surfaces on quartz. At the same time, to avoid detrimental modification of the photoresist during etching (e.g. reticulation), we use low RF power and apply thermal grease to transfer heat between the substrate and carrier wafer. We carry out the etch using an Oxford 100 PlasmaLab, with pressure 4.5 mTorr, RF power 90 W, SF₆ flow rate 4 sccm, Ar flow rate 14 sccm and helium backing on. This recipe typically gives a DC offset of 360 V with a 0.5 mm silica carrier wafer, S1818 resist etch rate of ˜100 nm/min and fused silica etch rate of ˜25 nm/min.

During the etch, defects on and inside the substrates could be exposed and further magnified by the plasma, which typically result in pits of few to tens of nanometer depth on the mirror surface. Such defects could come from surface and subsurface damage introduced by polishing processes and ion impurities in manufacture processes, and a simple way to test their presence is to etch a witness substrate without patterning. Photoresist quality is also an important factor, and we find careful handling and storage conditions to be important in avoiding defects.

Finally, we note that our fabrication flow can in principle be applied to other common materials, for example silicon, GaAs, and sapphire, as long as they can be polished to the necessary level and their etch recipe can be tuned to preserve surface quality.

### Example 3—Mirror Characterization

### A. Cavity Mode Simulation

When targeting ultrahigh finesse, it is important to consider any possible sources of loss caused by the fabrication technique. In particular, scattering from surface defects and clipping losses due to mirror shape errors are of concern. To guide our development process and lend confidence in the mirror template quality prior to optical coating, we employ numerical simulation techniques to predict mirror losses. Our tools build on several previously established techniques. First, one can utilize Fourier optics to simulate a beam undergoing repeated rounds of propagation, and monitor the rate at which energy decays (due to propagation outside the finite mirror). Alternatively, one can employ an eigenmode analysis technique, in which a round trip of cavity propagation is encoded in a scattering matrix, whose complex eigenvalues can be calculated to find mode frequencies and loss rates. In a separate work, we cross-check these techniques against each other and verify their ability to simulating these ultrahigh finesse values. By inputting measured mirror profilometry data to these tools, we can simulate the expected scattering/clipping loss of the mirror profiles after etching. In general, we find that our fabrication technique is consistently able to produce scattering/clipping losses at the ppm level. Even for distinctly non-parabolic surfaces, we typically find that the mirrors can still support ultrahigh finesse, albeit with modes that deviate from traditional Gaussian modes. In fact, these simulation tools can also help guide the development of alternative mirrors for intentionally forming non-Gaussian resonators

### B. Finesse Measurement

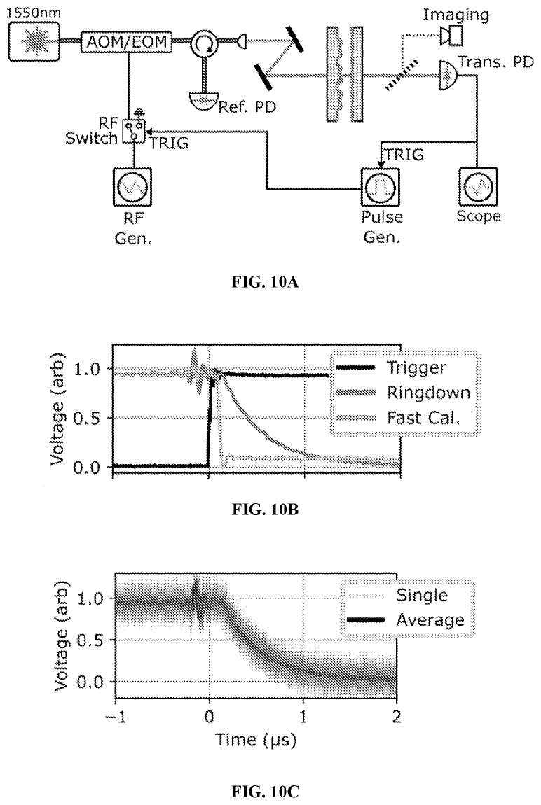

Finesse measurements were obtained from optical ringdowns (FIG. 10A), in which a laser is brought on resonance, then switched off abruptly. The exponential decay of the transmitted light can be fit to extract the cavity lifetime. Depending on the length of the cavity, the ringdown times varied from 400 ns to 10 s of μs. For longer (shorter) ringdowns, the laser was switched off by switching off the RF drive to an AOM (EOM), thus cutting off the laser carrier (sideband). The RF switch was triggered by a pulse, generated when the transmission reached a certain threshold voltage, indicating that the laser was on resonance. For the faster decay times, it is important to confirm that the response time of the whole system (the pulse generator, RF switch, optical modulator, photodetector, and any amplifiers) is sufficiently fast to measure the intended signal without distortion. To test this, we used a separate optical resonator with a much faster decay (˜5 ns), as illustrated in the calibration curve of FIG. 10B. We find that the response time is ≤50 ns, indicating a sufficiently fast bandwidth for our measurements. Note that we also implement averaging of many ringdowns to improve SNR, as illustrated in FIG. 10C.

### INCORPORATION BY REFERENCE

The entire contents of all patents, published patent applications, and other references cited herein are hereby expressly incorporated herein in their entireties by reference.

### EQUIVALENTS

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A mirror comprising:
a radius of curvature between about 10⁻⁴ m and about 10⁻² m; and
a finesse greater than about 10⁶ with a center wavelength between about 200 nm and about 5 microns.

2. The mirror of claim 1, wherein the finesse of the mirror is greater than about 10⁶ over wavelengths selected from the group consisting of: ultraviolet (UV), visible light, and infra-red.

3. A mirror comprising:
a radius of curvature between about 10⁻⁴ m and about 10⁻² m; and
sub-Angstrom surface roughness.

4. The mirror of claim 3, wherein the mirror is reflective of one or more wavelengths selected from the group consisting of: ultraviolet (UV), visible light, and infra-red.

5. A mirror comprising a substrate, wherein the substrate comprises one or more patterns erected on a surface thereof, and wherein the one or more patterns have a smooth and curved side and a concave center.

6. A method of fabricating a mirror, the method comprising:
flowing photoresist onto a substrate;
removing a portion of the photoresist;
subjecting a remaining portion of the photoresist to reflow under exposure to a solvent vapor;
etching the substate and the remaining portion of the photoresist to produce an etched substrate; and
applying a mirror coating the etched substrate.

7. The method of claim 6, wherein the removing step further comprises one or more selected from the group consisting of: exposure to pattern of light, exposure to an electron beam, and machining.

8. The method of claim 7, wherein the photoresist is selected from the group consisting of: positive photoresist and negative photoresist.

9. A mirror fabricated according to the method of claim 6.

10. A Fabry-Pérot resonator comprising:
a first mirror;
a second mirror parallel to the first mirror such that light is reflected between the first mirror and the second mirror;
wherein at least one of the first mirror or the second mirror is a mirror according to claim 1.

11. The Fabry-Pérot resonator of claim 10, wherein the Fabry-Pérot resonator acts as a stable Gaussian beam resonator.

12. The Fabry-Pérot resonator of claim 10, further comprising:
a spacer between the first mirror and the second mirror.

13. The Fabry-Pérot resonator of claim 12, wherein each of the first mirror, the second mirror, and the spacer consist of ultra-low-expansion (ULE) glass.

14. A Fabry-Pérot resonator comprising:
a first mirror;
a second mirror parallel to the first mirror such that light is reflected between the first mirror and the second mirror;
wherein at least one of the first mirror or the second mirror has a diameter less than or equal to five times a waist width of a Gaussian beam confined by the first mirror and the second mirror.

15. The Fabry-Pérot resonator of claim 14, further comprising:
a spacer between the first mirror and the second mirror.

16. The Fabry-Pérot resonator of claim 15, wherein each of the first mirror, the second mirror, and the spacer consist of ultra-low-expansion (ULE) glass.

17. A Fabry-Pérot resonator integrated with a photonic integrated circuit.
